(19) United States
(12) Patent Application Publication
(10) Pub. No.: US 2025/0135495 A1
(43) Pub. Date: May 1, 2025

(54) Dual Deck Vibratory Screening Bucket

(71) Applicant: Dual Force Technology, LLC, Austin, TX (US)

(72) Inventor: Paul Michael Esposito, JR., Plano, TX (US)

(21) Appl. No.: 18/988,602

(22) Filed: Dec. 19, 2024

Related U.S. Application Data
(60) Provisional application No. 63/593,351, filed on Oct. 26, 2023.

(51) Int. Cl. B07B 1/40; B07B 1/36; B07B 1/46

(52) U.S. Cl. CPC B07B 1/40; B07B 1/36; B07B 1/46; B07B 2201/04

(57) ABSTRACT

A dual deck vibratory screening bucket having a universal connecting mount affixed to the its rear wall for detachably securing the dual deck vibratory screening bucket to a piece of equipment having a skid steer. The screening bucket is configured with two screening decks, a lower screening deck having a screen element removably connected thereto and a top screening deck having a screen element removably connected thereto. Each screening deck is detachably secured to a vibrating frame which is housed and affixed within the main bucket frame. The vibrating frame is powered by dual hydraulic motors, thereby enabling the main bucket frame to vibrate. When the dual deck screening bucket is manipulated to dig and scoop material into the bucket, the vibration created by the vibrating frame enables the material within the bucket to be separated into three particle sizes.

### CROSS-REFERENCE TO RELATED APPLICATIONS

This application claims priority from U.S. Provisional Application 63/593,351, filed Oct. 26, 2023, and incorporates the filing in its entirety.

### FIELD OF INVENTION

The present invention relates to a dual deck vibratory screening bucket which is designed as an attachment to skid loaders and other similar machinery including excavators and wheel loaders. More particularly, the present invention relates to a dual deck vibratory screening bucket which allows for the separation of materials into three different sizes in a single pass.

### BACKGROUND OF THE INVENTION

Vibratory screeners are used in diverse fields of commerce including, for example, transportation, construction industry, food industry, cleaning industry, and waste management, to name but a few. While numerous vibratory screening apparatus are available commercially, all are cumbersome to operate and have low mobility. Traditionally, screening and sorting materials require multiple pieces of equipment, manual labor, and significant time. These issues lead to increased operational costs, potential safety risks, and decreased efficiency.

### PRIOR ART

The prior art is replete with devices which perform screening and sorting materials of different sizes. U.S. Pat. No. 5,219,078 to Hadden, issued Jun. 15, 1993, U.S. Pat. No. 9,344,342 B1 to Meyers, issued May 9, 2017, U.S. Patent Application Publication 2017/0130541 A1 to Caldwell, published May 11, 2017, U.S. Pat. No. 10,047,577 B2 to Bailey, issued Aug. 14, 2018, CA Patent Application 3022917 A1 to Gronvall, published Nov. 9, 2017 and EP 3532212 B1 to Larsson, published Apr. 9, 2019, are considered to be representative of the state of the art disclosing devices and equipment which screen and sort materials into various sizes.

A need still exists for a dual deck vibratory screening bucket which has attachment compatibility with various types of machines having a skid steer. Such as screening bucket should increase efficiency by screening materials into three sizes in one operational pass, thereby eliminating the need for multiple tools and increased manual labor. Such a screening bucket also should have a quick-change system for the screening panels to adapt to various types of materials and sizes, thereby ensuring its utility across different jobs. Such a screening bucket should include a vibration reduction mechanism to ensure that the operator's experience is smooth and without the jarring sensations typically associated with vibratory machinery. And, by mechanizing the sorting process with one screening bucket attachment, manual labor needs will be reduced and the risk of injuries associated with material handling and sorting will be minimized. Such a dual deck vibratory screening bucket should revolutionize material handling and sorting in construction and excavation, providing a multi-faceted solution that increase efficiency, versatility, and safety while reducing costs and discomfort to the operator.

### SUMMARY OF THE INVENTION

The invention of the present subject matter relates to dual deck vibratory screening bucket comprising a main bucket frame comprising a rear wall with a universal connecting mount for detachably securing the dual deck vibratory screening bucket to a piece of equipment, a vibrating frame housed and affixed within the main bucket frame, a lower screening deck detachably connected to the vibrating frame, a top screening deck detachably connected to the vibrating frame, and dual hydraulic motors affixed to the rear wall of vibrating frame, the dual hydraulic motors delivering an output force with adjustable amplitude and frequency. In operation, the dual deck vibratory screening bucket enables material captured within the bucket to be sorted efficiently into three sizes.

Accordingly, it is an object of the present subject matter to provide a dual deck vibratory screening bucket which can be easily and quickly attached and removed to a piece of equipment having a skid steer.

It is another object of the present subject matter to provide a dual deck vibratory screening bucket which can be easily and quickly attached to skid loaders, excavators, and wheel loaders.

It is still another object of the present subject matter to provide a dual deck vibratory screening bucket containing two screening decks, each screen deck having a quick-attach locking mechanism, thereby enabling an operator to switch the screening panels effortlessly.

It is a yet another object of the present subject matter to provide a dual deck vibratory screening bucket capable of screening and sorting materials into three different sizes within one operational pass.

It is a further object of the present subject matter to provide a dual deck vibratory screening bucket having a strong digging frame manufactured with high-strength steel to withstand the rigors of excavation and material handling.

It is yet a further object of the present subject matter to provide a dual deck vibratory screening bucket having a top screening deck which can be removed entirely.

It is still a further object of the present subject matter to provide a dual deck vibratory screening bucket wherein each screening deck has a screen element removably connected thereto.

It is an additional object of the present subject matter to provide a dual deck vibratory screening bucket wherein both the lower screening deck and the top screening deck have removable and customizable screen elements.

It is still another object of the present invention to provide a dual deck vibratory screening bucket having a vibratory motion driven by dual hydraulic motors which are positioned at the rear of the unit, generating up to 5,770 lbs. of output force with adjustable amplitude and frequency.

It is a further object of the present invention to provide a dual deck vibratory screening bucket having a reversible cutting edge and removable custom-sized teeth.

These and other objects of the present subject matter are accomplished by providing a dual deck vibratory screening bucket comprising a main bucket frame having a rear wall and two side walls, a vibrating frame housed and affixed within the main bucket frame, a lower screening deck detachably secured to the vibrating frame by a quick-attach locking mechanism, a first screen element removably connected to the lower screening deck, a top screening deck detachably secured to the vibrating frame by a quick-attach locking mechanism, a second screen element removably connected to the top screening deck, a universal connecting mount affixed to the rear wall of the main bucket from, the universal connecting mount being designed and configured for compatibility with industry standard skid loaders, a hydraulic flow control system integrated with dual hydraulic motors affixed to the rear wall of the vibrating frame, and a plurality of dampers secured to the rear wall and side walls of the main bucket frame and to the vibrating frame.

### BRIEF DESCRIPTION OF DRAWINGS

FIG. 1 is a top perspective view of the dual deck vibratory screening bucket of the present subject matter.

FIG. 2 is an exploded view of the dual deck vibratory screening bucket of the present subject matter.

FIG. 3 is a front perspective view of the dual deck vibratory screening bucket of the present subject matter.

FIG. 4 is a rear perspective view of the dual deck vibratory screening bucket of the present subject matter.

FIG. 5 is a side perspective view of the dual deck vibratory screening bucket of the present subject matter.

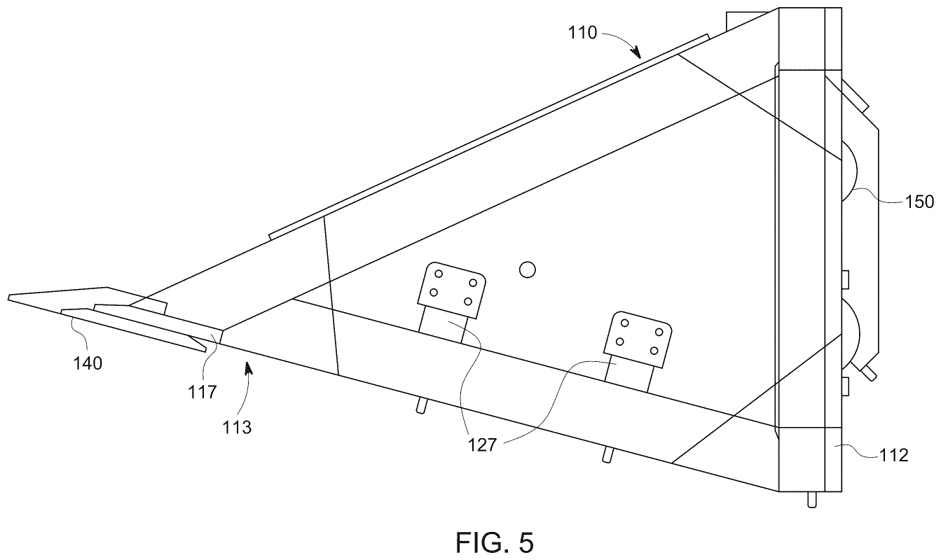

FIG. 6 is an oblique perspective view of the dual deck vibratory screening bucket of the present subject matter attached to a bobcat.

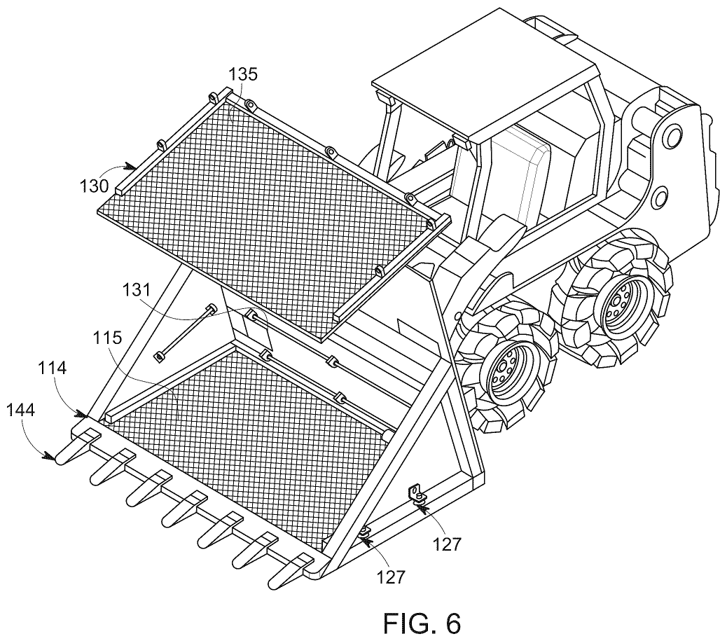

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The terms “screen bucket”, “vibratory screen bucket, “dual deck screen bucket”, “screening bucket”, “vibratory screening bucket, “dual deck screening bucket”, derivative terms and similar terms may be used throughout the specification and it is to be understood that such terms are interchangeable and all refer to the dual deck vibratory screening bucket of the present subject matter.

Also, it is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

The present subject matter is directed a dual deck vibratory screening bucket having a universal connecting mount affixed to the back surface of the rear wall for detachably securing the dual deck vibratory screening bucket to a piece of equipment having a skid steer. Examples of such pieces of equipment, included, but are not limited to skid loaders, bobcats, excavators, and wheel loaders. The screening bucket is configured with two screening decks, a lower screening deck and a top screening deck, both screening decks being detachably secured to a vibrating frame which is housed and affixed within the main bucket frame of the dual deck vibratory screening bucket. The vibratory frame is powered by dual hydraulic motors affixed to the rear wall of the vibratory frame, thereby enabling the main bucket frame and the two screening decks to vibrate. In operation, the dual deck vibratory screening bucket is manipulated to dig and scoop material into the bucket. Vibration created by the vibrating frame enables the material within the bucket to be screened and sorted efficiently into three particle sizes in a single operational pass. Larger sized particles remain on the top screening deck, mid-size materials are sorted and captured on the lower screening deck and finer particles are dispersed from the lower screening deck onto the ground or pre-selected surface. This sorting process eliminates the need for additional sorting equipment, reducing costs and increasing on-site efficiency. The vibratory motion, adjustable through hydraulic flow, ensures optimal sorting regarding of material density or moisture content.

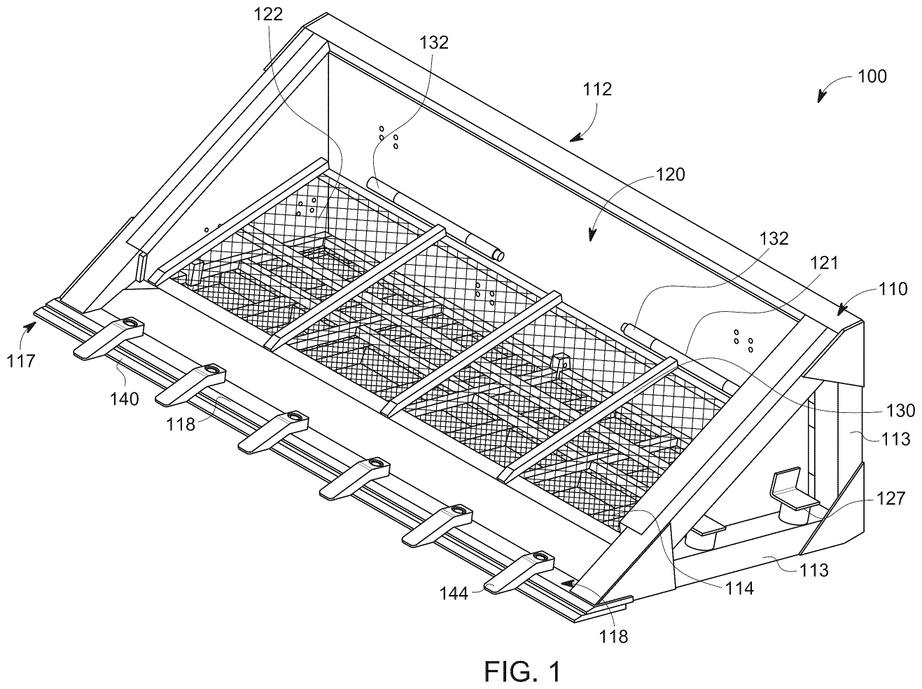

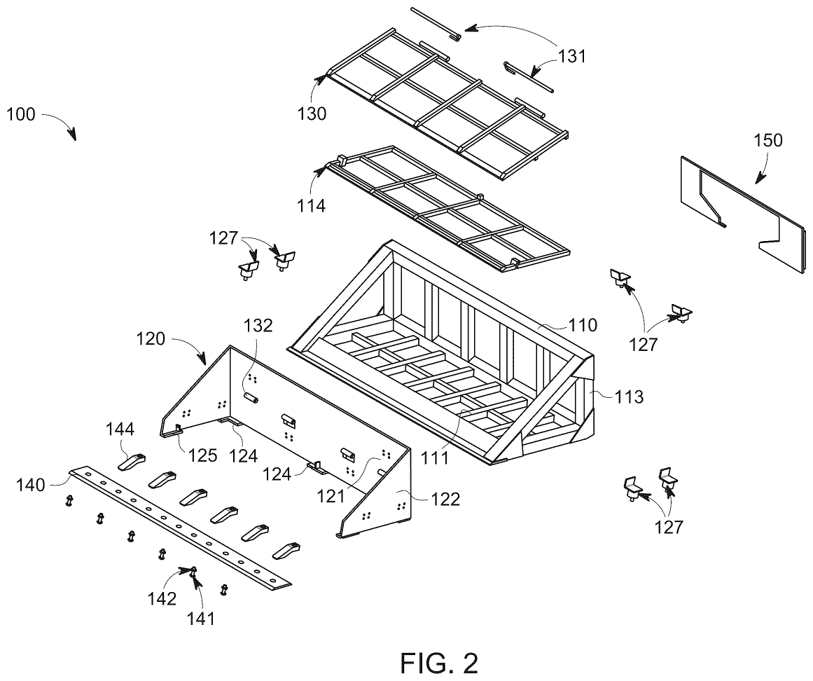

Referring to FIG. 1 and FIG. 2, a dual deck vibratory screening bucket 100 is shown comprising a main bucket frame 110 having a lower deck 111, a rear wall 112 and two side walls 113 connecting the lower deck to the rear wall. The screening bucket 100 further comprises a vibrating frame 120 which is housed and affixed within the main bucket frame, a lower screening deck 114 configured to be detachably secured to the vibrating frame, the lower screening deck having a first screen element 115 removably connected thereto, a top screening deck 130 detachably secured to the vibrating frame, the top screening deck having a second screen element 135 removably connected thereto. In operation, the screening bucket first is positioned to dig into the earth or other material and scoop various sized particulate material. Vibrating motion from the vibrating frame wall causes the various sized particulate material to begin to be screened and sorted. During the dumping process, the final screening and sorted is achieved.

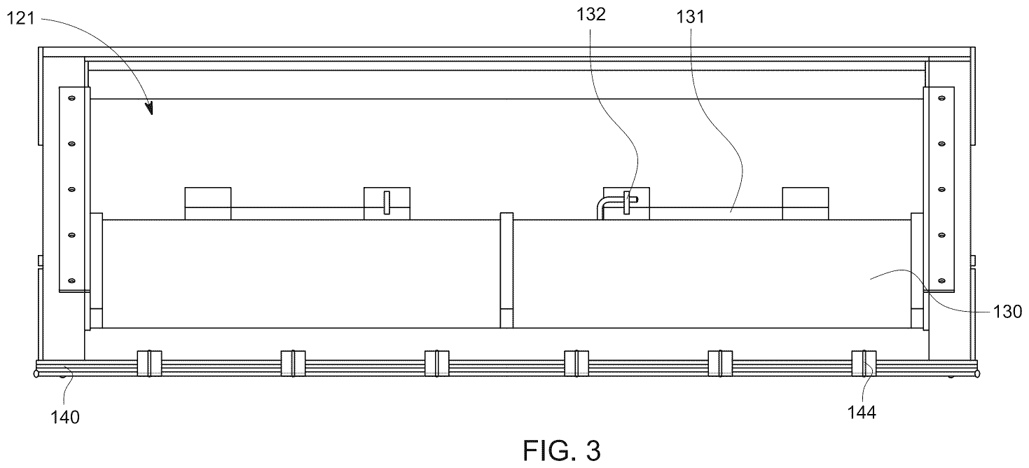

In a preferred embodiment, the lower screening deck 114 is detachably secured to the vibrating frame 120 by engagement with a quick-attach locking mechanism comprising rear fixation elements 124 and front fixation elements 125. The top screening deck 130 is detachably secured to the vibrating frame by means of a quick-attach locking mechanism comprising quick-attach locking pins 131 and hinge shafts 132. As shown in FIG. 2 and FIG. 3, the quick attach locking pins 131 are detachably secured to the vibrating frame with the hinge shafts 132. The quick-attach locking mechanisms facilitate making screen changes fast and easy. During the dumping process, the quick-attach locking mechanism functions as a hinge and pivot point such that the top screening deck can open and close freely based on the angle of the screening bucket. In operation, when the top screening deck opens at a 45° angle, mid-sized particles and smaller particulate materials exit through second screen element 135 and onto the first screen element. Upon returning to the operational position, the quick-attach locking mechanism of the top screening deck ensures precise re-alignment with an allowable tolerance of ±3.0°, thereby minimizing operator adjustments. The quick-attach locking mechanism of the top screening deck eliminates manual intervention, improving productivity and safety during operation.

The main bucket frame is crafted with high-strength steel to withstand the rigors of excavation and material handling, thereby providing an external frame which is robust for heavy digging applications.

Both the lower screening deck 114 and the top screening deck 130 feature quick-change mechanisms, allowing operators two swap out screen elements with minimal downtime. Each screening element can be customized to filter materials ranging from about 1/16″ up to about 3.0″. Depending on the application, the screening elements can be composed from steel, rubber, or poly materials, providing flexibility based on the specific material and environmental conditions. For instance, rubber or poly screens may be used for wet, sticky, or corrosive materials, while steel screens are ideally suited for handling abrasive materials. By providing each screening deck with quick-change mechanisms, the dual deck vibratory screening bucket of the present subject matter enables the operator to swap screens effortlessly, thereby allowing for diverse applications and adaptability to different tasks, including mining, recycling, and landscaping.

As shown in the Figures, the dual deck vibratory screening bucket further comprises a reversible cutting edge 140 which is secured to the underside 117 of the lower deck 111 by means well known in the art, such as with carriage bolts 141 and flange locknuts 142, enabling easy replacement or inversion for extended wear life, and a plurality of custom-sized teeth 144, secured to the lower deck front edge 118, ensuring durability in high-impact environments. The teeth 144 can be secured to the lower deck front edge by means well known and obvious to those skilled in the art. In the preferred embodiment, the custom-sized teeth are bolted securely to the lower deck front edge 118. Also in a preferred embodiment, the teeth 144 are aligned to the lower deck front edge 118 with defined spacing. The custom-sized teeth are made from high-strength steel to maximize digging efficiency.

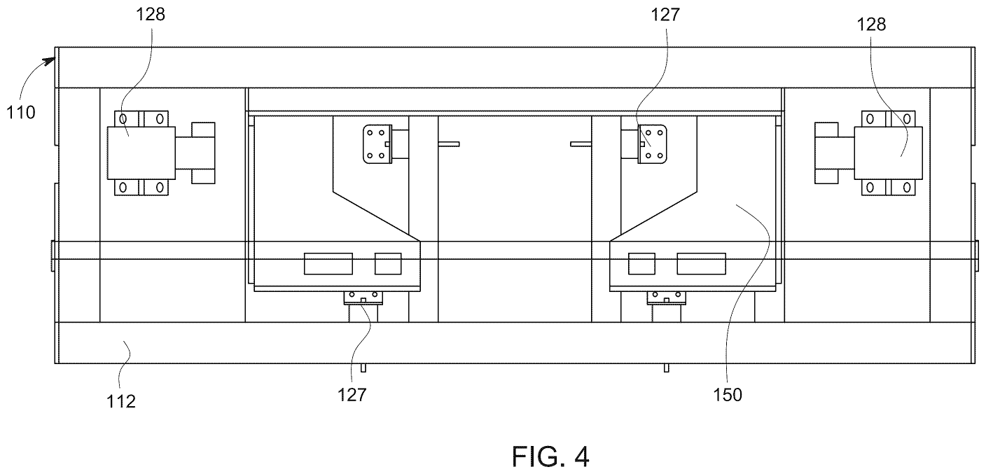

The vibratory frame 120 comprises a rear wall 121 and two side walls 122 which complement the rear wall 112 and side walls 113 of the main bucket frame 110. More specifically, the vibratory frame rear wall 121 fits against and engages the rear wall of the main bucket body and the vibratory frame side walls 122 fit snugly against the bucket frame side walls 113 via attachment to vibratory dampers 127. Referring to FIG. 4, dual hydraulic motors 128 are mounted on the back side of the rear wall 121 of the vibrating screen to deliver a vibratory motion of the vibrating wall housed within the main bucket body. These motors deliver up to 5,770 lbs. of output force with adjustable amplitude and frequency. The adjustment is facilitated through hydraulic flow from the carrier equipment. This feature allows the operator to customize vibration intensity based on material density and moisture levels. The enclosed design of the hydraulic motor housing protects against dust, debris, and environmental damage, ensuring reliable performance in harsh conditions. Housing the vibrating frame within the main bucket frame significantly reduces vibration transmission to the operator and machinery, enhancing operator comfort and equipment longevity.

A plurality of vibratory dampers 127 are strategically positioned on the rear wall and the side walls of the main bucket frame and affixed to the rear wall and side walls of the vibrating frame. These vibratory dampers absorb and dissipate vibrational forces which reduces transmission to the skid loader or carrier equipment, thereby enhancing operator comfort and extending equipment life. Each damper 127 is constructed from high durability rubber composite materials, ensuring effective performance under sustained operational loads.

The dual deck vibratory screening bucket of the present subject matter includes hardened steel cutting edges and abrasion-resistant components, thereby ensuring longevity and reliable performance across demanding applications including demolition, recycling, construction, mining, composting, and landscaping, to name but a few examples. The user-friendly and versatile mounting attachment to a piece of equipment having a skid steer provides a practical solution for on-site screening with the additional convenience of the customizable screen elements for varied sorting material requirements.

Referring to FIG. 4, a universal connecting mount 150 is welded to the back side of the rear wall of the main bucket frame, designed and configured for compatibility with industry-standard skid loaders. The welded construction ensures durability and reliable performance during heavy-duty operations. The universal design simplifies attachment to a wide range of equipment, increasing the versatility of the screening bucket across applications. The universal connecting mount 150 can be attached to any piece of equipment having a skid steer, including skid loaders, excavators, and wheel loaders. With this simplified attachment feature, the dual deck vibratory screening bucket becomes a groundbreaking addition in the field of digging and excavation.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for . . . .”

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A dual deck vibratory screening bucket comprising:
a. a main bucket frame having a lower deck, a rear wall having a back surface, two side walls, a lower deck front edge, and an underside;
b. a universal connecting mount affixed to said back surface of said rear wall, said universal connecting mount being configured to be detachably secured to a piece of equipment having a skid steer;
c. a vibrating frame having a rear wall and two side walls, said vibrating frame housed and affixed within said main bucket frame;
d. a lower screen deck detachably secured to said vibrating frame;
e. a first screen element removably connected to said lower screen deck;
f. a top screening deck detachably secured to said vibrating frame, and
g. a second screen element removably connected to said top screening deck,
wherein said vibratory frame is powered to deliver vibration of said dual deck vibratory screening bucket.

2. The dual deck vibratory screening bucket in accordance with claim 1, wherein said universal connecting mount can be detachably secured to pieces of equipment including skid loaders, excavators, and wheel loaders.

3. The dual deck vibratory screening bucket in accordance with claim 1, wherein said top screening deck is detachably secured to said vibrating frame by a quick-attach locking mechanism.

4. The dual deck vibratory screening bucket in accordance with claim 1, said top screening deck is detachably secured to said vibrating frame by a quick-attach locking mechanism comprising quick attach locking pins and hinge shafts.

5. The dual deck vibratory screening bucket in accordance with claim 4, wherein during a dumping operation, said quick-attach locking mechanism is configured to automatically release and re-lock the top screening deck at predetermined angles, with an allowable tolerance of ±3°.

6. The dual deck vibratory screening bucket in accordance with claim 1, wherein said lower screening deck is detachably secured to said vibrating frame by a quick-attach locking mechanism.

7. The dual deck vibratory screening bucket in accordance with claim 6, wherein said vibrating frame comprises rear fixation elements and front fixation elements, and wherein said lower screening deck is attached to said vibrating frame by engagement with said rear fixation elements and said front fixation elements.

8. The dual deck vibratory screening bucket in accordance with claim 1, wherein said first screen element and said second screen element each can be customized to screen materials from about 1/16″ to about 3.0″.

9. The dual deck vibratory screening bucket in accordance with claim 8, wherein each of said first screen element and said second screen element are composed of materials selected from the group consisting of steel, rubber, and poly materials.

10. The dual deck vibratory screening bucket in accordance with claim 9, wherein screen elements composed of rubber and poly materials are selected for screening and sorting wet, sticky, or corrosive materials, and wherein screen elements composed of steel materials are selected for screening and sorting abrasive materials.

11. The dual deck vibratory screening bucket in accordance with claim 1, further comprising a reversible cutting edge which is detachably secured to said underside of said lower deck.

12. The dual deck vibratory screening bucket in accordance with claim 1, further comprising a plurality of custom-sized teeth elements, each of said custom-sized teeth elements being removably secured to said lower deck front edge.

13. The dual deck vibratory screening bucket in accordance with claim 1, wherein said vibratory frame is powered by dual hydraulic motors affixed to rear wall of said vibrating frame.

14. The dual deck vibratory screening bucket in accordance with claim 13, wherein said dual hydraulic motors generate up to about 5,770 lbs. of output force.

15. The dual deck vibratory screening bucket in accordance with claim 14, further comprising a hydraulic flow control system integrated with said dual hydraulic motors to provide real-time adjustment of amplitude and frequency to optimize performance for varying material densities.

16. The dual deck vibratory screening bucket in accordance with claim 13, wherein, in operation, said dual hydraulic motors deliver a vibrating motion to said vibrating frame wall housed within said main bucket frame.

17. The dual deck vibratory screening bucket in accordance with claim 10, further comprising a plurality of vibrating dampers positioned along said rear wall and said side walls of said main bucket frame and affixed to said rear wall and said side walls of said vibrating frame to facilitate the reduction of vibration transmission to an operator.

18. The dual deck vibratory screening bucket in accordance with claim 1, wherein said universal connecting mount is welded to said back side of said main bucket frame.

19. The dual deck vibratory screening bucket in accordance with claim 1, wherein said main bucket frame is manufactured with high-strength steel to withstand the rigors of excavation and material handling.

20. The dual deck vibratory screening bucket in accordance with claim 1, wherein when said universal connecting mount is detachably secured to a piece of equipment and manipulated to dig and scoop material into said screen bucket, vibrating motion delivered from said vibrating frame enables material within said dual deck vibratory screening bucket to be screened and sorted into three particulate sizes, the largest particulate size being retained on said second screen element, the mid-size particulate size being retained on said first screen element and the smallest particulate size being sorted and dispersed from said first screen element and through said lower deck.

21. The dual deck vibratory screening bucket in accordance with claim 13, wherein when said universal connecting mount is detachably secured to a piece of equipment and manipulated to dig and scoop material into said screening bucket, vibrating motion delivered from said vibrating frame enables material within said screening bucket to be screened and sorted into three particle sizes, the larger particles being retained on said second screen element, the mid-size particles being retained on said first screen element and the smallest particles being sorted and dispersed from said first screen element and through said lower deck.

22. The dual deck vibratory screening bucket in accordance with claim 1, configured to screen and sort material retained within said screening bucket into three particle sizes.
